(19) United States
(12) Patent Application Publication
(10) Pub. No.: US 2005/0178261 A1
(43) Pub. Date: Aug. 18, 2005

(54) Saw blade and saw having an oscillatory drive

(76) Inventor: Walter Thomaschewski, Filderstadt (DE)

Correspondence Address: ST. ONGE STEWARD JOHNSTON & REENS, LLC, 986 BEDFORD STREET, STAMFORD, CT, 06905-5619, US

(21) Appl. No.: 10/855,082

(22) Filed: May 27, 2004

(30) Foreign Application Priority Data
May 28, 2003 (DE) 203 08 797.6

(51) Int. Cl. B26D 1/12

(52) U.S. Cl. 83/666

(57) ABSTRACT

A saw comprising an oscillatory drive for oscillatingly driving a drive shaft about its longitudinal axis is disclosed. The saw comprises a saw blade being driven oscillatingly by the drive shaft and further comprises a mounting section comprising a mounting opening for engaging the drive shaft of the oscillatory drive positively or non-positively. The working section has a cutting edge comprising a series of cutting teeth, wherein at least the cutting edge is made of bimetal. Also preferably there is provided on both sides of the saw blade adjoining the cutting edge a coating comprising diamond grinding particles.

This application claims priority of pending German Patent Application No. 203 08 797.6 filed May 28, 2003.

### BACKGROUND OF THE INVENTION

The invention relates to a saw having a rotary oscillating drive motion, comprising a saw blade comprising a mounting section having a mounting opening for engaging a drive shaft which is driven oscillatingly about its longitudinal axis, and further comprising a working section which is provided with a cutting edge having a series of cutting teeth.

Such a saw blade and such a saw are known from EP-A-0 881 023.

Such saw blades are driven by a rotary oscillating drive the drive shaft of which is driven oscillatingly about its longitudinal axis at high frequency in the range between about 5,000 to 25,000 oscillations per minute and at small pivot angle between about 0.5° and 7°.

Using such saw blades in combination with an oscillatory drive special sawing tasks can be performed, such as sawing operations on car body parts or sawing operations at difficultly accessible locations. Meanwhile, such saw blades are used for various sawing operations, such as for sawing wood, putty and soft materials, however, also for sawing glass fiber reinforced materials, carbon fiber reinforced materials and metal sheets of small thickness. Cuts can be performed at right angles without intersections. Also cutting operations can be performed at difficultly accessible locations and special cutouts can be generated on wood, gypsum plaster board and many classic materials.

Depending on the material to be sawed different saw blades must be used.

This is a disadvantage, since the exchange of saw blades is time consuming. Also for such a sawing operation saw blades are desired having a long operating live which must not be exchanged often.

### SUMMARY OF THE INVENTION

It is a first object of the invention to disclose a saw with a rotary oscillatory drive that allows for a broad range of applications, in particular for sawing various materials without any need to exchange the saw blade.

It is a second object of the invention to disclose a saw with a rotary oscillatory drive wherein the saw blade is sturdy and offers a long operating live.

It is a third object of the invention to disclose a saw with a rotary oscillatory drive wherein the saw blade offers a high resistance against breaking.

It is a fourth object of the invention to disclose a saw with a rotary oscillatory drive which allows to make clean cuts on various materials within a single operation without any need for finishing the cut material by additional grinding steps or the like.

It is a fifth object of the invention to disclose a saw blade for use with a rotary oscillatory drive that allows for a broad range of applications, in particular for sawing various materials without any need to exchange the saw blade.

It is a sixth object of the invention to disclose a saw blade for use with a rotary oscillatory drive wherein the saw blade is sturdy and offers a long operating live.

It is a seventh object of the invention to disclose a saw blade for use with a rotary oscillatory drive wherein the saw blade offers a high resistance against breaking.

It is a further object of the invention to disclose a saw blade for use with a rotary oscillatory drive wherein the saw blade allows making clean cuts on various materials within a single operation without any need for finishing the cut material by additional grinding steps or the like.

These and others are achieved according to the invention by a saw comprising an oscillatory drive for oscillatingly driving a drive shaft about its longitudinal axis, and further comprising a saw blade being driven oscillatingly by the drive shaft and comprising a mounting section comprising a mounting opening for engaging the drive shaft of the oscillatory drive positively or non-positively, and further comprising a working section having a cutting edge comprising a series of cutting teeth, wherein at least the cutting edge is made of bimetal.

By making the cutting edge of bimetal the stability and operating live is considerably enhanced when compared to prior art saws. Simultaneously, when designing the cutting edge of bimetal various materials can be sawed, such as soft wood, hard wood, plastics as well as metals up to a certain thickness. All in all, the operating range as well as the operating live of the saw according to the invention and of the saw blade according to the invention, respectively, are considerably improved.

According to a preferred development of the invention the cutting edge comprises a set of teeth, preferably a wave set of teeth.

With such a design metal sheets and metal profiles can be sawed advantageously.

According to a further development of the invention the working section on at least one surface thereof, preferably at both surfaces thereof, comprises a coating comprising a grinding material, preferably a coating comprising diamond or hard metal grinding particles.

Herein the coating preferably adjoins to the cutting edge.

These measures offer the advantage that a cut can be performed in such a way that the cut material does not require any finish treatment by grinding or the like.

According to a further design of the invention the saw blade has a longitudinal shape, wherein the mounting section extends from one end to the working section at an opposite end.

With such a longitudinal shape cuts can be performed under geometrically very restrained conditions. In particular, cut-outs can be made on wooden plates or wooden profiles, on objects made of plastic, on gypsum plaster boards and the like, this being of particular advantage in construction work.

The working section of the saw blade may have an arcuate cutting edge, wherein the center of bending is preferably within the center of the mounting opening. In this way a cutting can be performed that offers particularly low vibrations.

To this end, the saw blade may comprise a circular or a partially circular cutting edge.

Thereby longer and deeper cuts can be performed in a relatively simple way.

According to an alternative design the working section comprises a cutting edge of straight or at least partially straight design. Also the cutting edge may have several sections arranged at an angle to each other.

Thereby cutouts can be generated in a particularly simple way on flat surfaces.

According to a further development of the invention the mounting opening of the saw blade is designed for a positive engagement with the drive shaft.

In this way, a safe mounting and power transmission is ensured also at higher torques.

According to a further design of the invention the saw blade is of bent-off design.

This allows working with the cutting edge directly flush along a surface.

It will be understood that the above-mentioned and following features of the invention are not limited to the given combinations, but are applicable in other combinations or taken alone without departing from the scope of the invention.

### BRIEF DESCRIPTION OF THE DRAWINGS

Further features and advantages of the invention will become apparent from the following description of preferred embodiments taken in conjunction with the drawings. In the drawings show:

FIG. 1 a view of a first embodiment of a saw blade according to the invention;

FIG. 2 a lateral view of a saw according to the invention, shown at the front and of a rotary oscillatory drive with a saw blade of bent-off configuration attached to its drive shaft;

FIG. 3 a top view of the saw blade according to FIG. 2;

FIG. 4 a top view of a further saw blade according to the invention which is configured as a circular bent-off saw blade;

FIG. 5 a top view of a further embodiment of a saw blade according to the invention;

FIG. 6 a top view of a further embodiment of a saw blade according to the invention; and

FIG. 7 a perspective partial view of a cutting edge having a wave set of teeth, shown from the front.

### DETAILED DESCRIPTION OF THE PREFERRED EMBODIMENTS

In FIGS. 1 and 3 saw blades are shown, the basic shape of which is generally known from EP-A-0 881 023. FIG. 4 shows a circular, bent-off saw blade which is also basically known in the prior art. According to the invention, the saw blades according to FIGS. 1 and 3 comprise additional coatings 19 and 19a, respectively, comprising diamond or a hard metal grinding particle.

All the saw blades described herein are particularly suited for mounting on a free end of a drive shaft of an oscillatory drive.

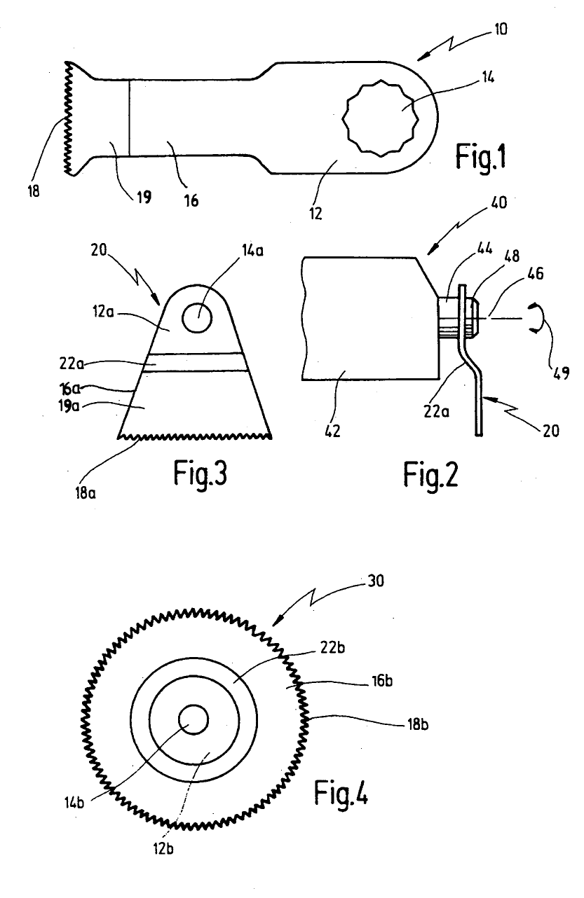

FIG. 2 shows such a saw 40 comprising an oscillatory drive 42. The oscillatory drive drives a drive shaft 44 about the longitudinal axis 46 of the drive shaft back and forth at high frequency, e.g. between 5,000 and 25,000 oscillations per minute and at a small pivot angle, e.g. 0.5° to 7°, as indicated by the double arrow 49. At the free end of the drive shaft 44 a support for the saw blade is provided which may be placed thereon and which may be fixed by means of a securing element 48, e.g. by a screw.

By contrast to the saw blades according to the prior art, the saw blades according to the invention, at least their cutting edges, are made of bimetal.

According to the design shown in FIG. 1, the saw blade designated in total with numeral 10 has a flat, longitudinal shape and at one end thereof comprises a mounting section 12 within which a star-shaped mounting opening 14 is provided for positively engaging the drive shaft 44 of the oscillatory drive 42. The mounting section 12 extends toward a working section 16 located at the opposite end. A cutting edge 18 provided with saw teeth and extending straight as shown here, is located at the outer rim of the working section 16. It will be understood that the cutting edge can also be designed arcuate or angled several times, although not shown here.

In the design shown in FIG. 1 the complete saw blade 10 is produced from a bimetal blank. E.g. it may be shaped by a stamping operation (possibly including the saw teeth). After a suitable heat treatment for hardening or annealing, respectively, the saw blade 10, possibly the saw teeth of the cutting edge 18 may be re-sharpened by grinding.

In addition, as already mentioned above, the saw blade 10 according to FIG. 1 on both sides is provided at the region adjoining the cutting edge 18 with a coating 19 which preferably is a coating comprising diamond grinding particles of the type D126. Alternatively, the coating may comprise fine hard metal grinding particles (hard metal grit).

Thereby it is made possible that when cutting a material using the cutting edge 18, simultaneously the surface of the cut is ground by means of the diamond comprising coating. Thus a clean cut can be provided by a single operation which does not require any finishing treatment.

According to FIGS. 2 and 3 a modified design of the saw blade according to the invention is designated in total with numeral 20. For similar parts the same reference numerals are used which may be followed by an “a”. The saw blade 20 according to FIGS. 2 and 3 comprises a mounting section 12a having an arcuate mounting opening 14a and extending from the mounting section 12a at an angle of about 30° to the working section 16a at the opposite end. At the outer end of the working section 16a again a straight cutting edge 18a is provided. In addition, at the transition between the mounting section 12a and the working section 16a a bend 22a is provided. Again, the region between the cutting edge 18a and the bend 22a is provided on both sides thereof with a diamond comprising coating of D126.

FIG. 4 shows a modified embodiment of a saw blade 30 which is configured circular and which carries in the center thereof a mounting section 12b having a circular mounting opening 14b. At the transition between the mounting section 12b and the working section 16b a bend 22b is provided. The cutting edge 18b is configured as a circular cutting edge comprising the saw teeth at the outer rim of the working section 16b.

For a simple and cost-effective manufacture in this design only the working section 16b is made of bimetal, while the mounting section 12b including the bend 22b is made of a common steel sheet, e.g. of a tool steel. The working section 16b of bimetal may e.g. be connected by laser welding with the mounting section 12b in the region of the bend 22b.

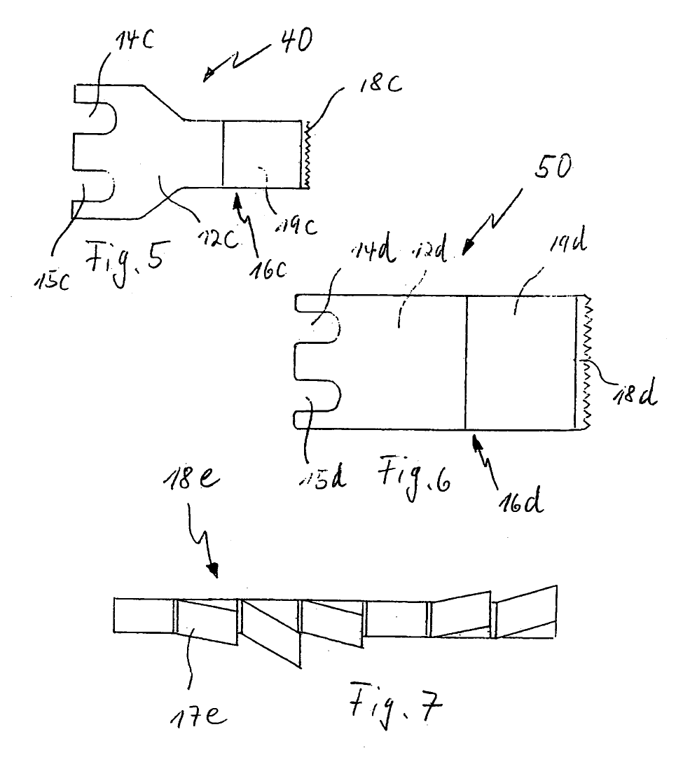

In FIGS. 5 and 6 two further embodiments of the invention are designated in total with numerals 40 and 50, respectively.

The saw blade 40 according to FIG. 5 comprises two oblong holes 14c and 15c arranged in parallel at the mounting section 12c and running out to the outside. This facilitates a mounting to a holder, such as known from EP-A-1 208 950. The saw blade 40 tapers from the mounting section 12c on both sides toward a smaller working section 16c. At the outer end of the working section 16c a cutting edge 18c made of bimetal is fixed by soldering or welding. Again the working section 16c on both surfaces in the region adjoining the cutting edge 18c is coated with a diamond comprising coating D126.

The saw blade 50 almost completely corresponds to the saw blade 40 shown in FIG. 5. The single difference rests in the fact that the saw blade 50, due to a broader cutting edge 18d, has uniform breadth beginning with the mounting section 12d up to the working section 16d.

In FIG. 7 a cutting edge 18e is shown from the front in enlarged view. The cutting edge comprises a set of teeth designed as a so-called “wave set of teeth”.

In this regard the term “set of teeth” shall define that the outermost parts of the teeth protrude beyond the two opposing flat surfaces of the working section of the saw blade. Now according to FIG. 7 the set of teeth is arranged in a wave. The teeth 17e “flow around” the center line of the cutting edge alternatingly to the one and to the other side. Such a wave set of teeth is particularly suited for sawing thin-walled sheets and profiles as well. Preferably, all the cutting edges 18, 18a, 18b, 18c, 18d are provided with such a wave set of teeth. By this design the range of possible materials to be cut is considerably broadened.

1. A saw comprising:
an oscillatory drive for oscillatingly driving a drive shaft about a longitudinal axis;
a saw blade being driven oscillatingly by said drive shaft about said longitudinal axis, said saw blade comprising:
a mounting section having a mounting opening for engaging said drive shaft of said oscillatory drive;
a working section having two opposing surfaces and a cutting edge;
wherein said cutting edge comprises a plurality of cutting teeth and is made of bimetal; and
wherein said working section on at least one of said two opposing surfaces comprises a coating comprising a grinding material.

2. The saw of claim 1, wherein said working section on both opposing surfaces thereof comprises a coating comprising a grinding material.

3. The saw of claim 1, wherein said grinding material comprises diamond grinding particles.

4. The saw of claim 1, wherein said material comprises hard metal grinding particles.

5. The saw of claim 1, wherein said coating is located adjoining said cutting edge.

6. The saw of claim 1, wherein said cutting edge comprises a set of teeth.

7. The saw of claim 6, wherein said cutting edge comprises a wave set of teeth.

8. The saw of claim 1, wherein said saw blade is configured longitudinally comprising a first end and a second end, said mounting section extending from said first end toward said working section and said second end.

9. The saw of claim 1, wherein said working section of said saw blade comprises an arcuate cutting edge defining a center being located in a center of said mounting opening.

10. A saw comprising:
an oscillatory drive for oscillatingly driving a drive shaft about a longitudinal axis;
a saw blade being driven oscillatingly by said drive shaft about said longitudinal axis; said saw blade comprising:
a mounting section having a mounting opening for engaging said drive shaft of said oscillatory drive;
a working section having two opposing surfaces and a cutting edge;
wherein said cutting edge comprises a plurality of cutting teeth and is made of bimetal.

11. A saw blade for a saw having a oscillatory drive for oscillatingly driving a drive shaft about a longitudinal axis;
said saw blade comprising:
a mounting section having a mounting opening for engaging said drive shaft of said oscillatory drive;
a working section having two opposing surfaces and a cutting edge;
wherein said cutting edge comprises a plurality of cutting teeth and is made of bimetal; and
wherein said working section on at least one of said two opposing surfaces comprises a coating comprising a grinding material.

12. The saw blade of claim 11, wherein said working section on both opposing surfaces thereof comprises a coating comprising a grinding material.

13. The saw blade of claim 11, wherein said grinding material comprises diamond grinding particles.

14. The saw blade of claim 11, wherein said material comprises hard metal grinding particles.

15. The saw blade of claim 11, wherein said coating is located adjoining said cutting edge.

16. The saw blade of claim 11, wherein said cutting edge comprises a set of teeth.

17. The saw blade of claim 16, wherein said cutting edge comprises a wave set of teeth.

18. The saw blade of claim 11, wherein said saw blade is configured longitudinally comprising a first end and a second end, said mounting section extending from said first end toward said working section and said second end.

19. The saw blade of claim 11, wherein said working section of said saw blade comprises an arcuate cutting edge defining a center being located in a center of said mounting opening.

20. The saw blade of claim 12, wherein said mounting section comprises two oblong mounting holes running out into an outer edge of said mounting section.
